(19) United States
(12) Patent Application Publication
(10) Pub. No.: US 2025/0019547 A1
(43) Pub. Date: Jan. 16, 2025

(54) PROCESS FOR PRODUCING A STORAGE-STABLE AQUEOUS PRIMER FOR GLASS AND CERAMIC SUBSTRATES

(71) Applicant: SIKA TECHNOLOGY AG, Baar (CH)

(72) Inventor: Antonio BAZZO, Zürich (CH)

(73) Assignee: SIKA TECHNOLOGY AG, Baar (CH)

(21) Appl. No.: 18/710,791

(22) PCT Filed: Jan. 19, 2023
(86) PCT No.: PCT/EP2023/051279

§ 371 Date: May 16, 2024

(30) Foreign Application Priority Data
Jan. 24, 2022 (EP) 22153053.8

(51) Int. Cl. C09D 5/00; C03C 17/34; C08K 3/34; C08K 5/5419

(52) U.S. Cl. CPC C09D 5/002; C03C 17/3405; C08K 3/34; C08K 5/5419

(57) ABSTRACT

A process for preparing an aqueous primer composition, including the steps performed in consecutive order: dissolving at least one organotitanate in a concentrated acid; adding water in an amount that the resulting volume ratio of (organotitanate and acid) to water is between 1:2 and 1:8 and/or the resulting pH is between 2 and 5, and waiting until a homogeneous, transparent solution is obtained; adding at least one organosilane; diluting the obtained mixture with additional water, until the resulting solution has a weight content of (organotitanate plus acid plus organosilane) of between 1% and 5% by weight, based on the total composition, and/or the resulting solution has a pH of between 2.5 and 4.5.

### TECHNICAL FIELD

The invention relates to a process for preparing an aqueous primer composition, especially an aqueous one-component composition, which is suitable as adhesion promoting primer for glass and ceramic substrates, as well as the composition itself and to the use thereof.

### Prior Art

Adhesive bonding of substrates using adhesives such as polyurethanes is a widely used technique in construction and manufacturing. However, some substrates (bonding substrates) can be problematic in this regard since they are unable to build up sufficient initial adhesion with certain adhesives, or there is loss of adhesion over time, particularly under demanding environmental conditions such as heat or humidity.

Adhesion promoter compositions that are applied to such problematic substrates before the adhesive in order to form an interlayer between the substrate and the adhesive have long been used for that reason, with the goal to improve adhesion or to maintain a proper adhesion over the lifetime of the adhesively bonded article. A particularly important field of use of adhesion promoter compositions is vehicle construction and assembly, since these applications involve difficult to bond substrates such as coated metals, ceramics, or plastics. Especially in direct glazing applications or the bonding of panes to vehicle bodywork, adhesion promoters are commonly used to improve the adhesive bond and ensure its longevity.

Typically, such compositions are organic or aqueous solutions containing dispersed or dissolved organosilanes, which enable an ideal interlayer for bonds of glasses and other materials once they have deposited and crosslinked on the substrates's surface. More particularly, such adhesion promoter compositions are used as primers and activators, i.e. as adhesion-promoting undercoat. Such compositions frequently contain inert, readily volatile solvents in order to assure rapid flash off (evaporation of the solvent). However, the content of organic solvent is disadvantageous in terms of environmental compatibility and occupational safety.

Aqueous adhesion promoter compositions based on organosilanes and containing water as solvent are known as EHS-friendly alternatives. However, they have some disadvantages. A problem with silane-based aqueous adhesion promoter compositions is that they have either relatively low storage stability (shelf-life) coupled with adequate reactivity or inadequate reactivity coupled with adequate storage stability. This is because the silanes used have hydrolyzable functional groups that are hydrolyzed on mixing with water to form silanol groups (Si—OH). Such silanol groups are frequently reactive and condense spontaneously with one another under formation of condensation products of relatively high molecular weight, which leads to insoluble precipitates in the adhesion promoter compositions and impairment of their function.

In addition, the use of aminosilanes and/or mercaptosilanes in such aqueous adhesion promoter compositions is known. The emulsifying of mercaptosilanes or oligosilane-mercaptosilane mixtures in water is particularly difficult since the mercaptosilanes are not water-soluble before the silane groups are hydrolyzed. In order to bring these silanes into water, prior to the hydrolysis, complete homogeneous distribution has to be assured. In addition, the pH has to be adjusted with acids, for example acetic acid, such that the condensation that occurs as a further reaction is slowed as far as possible. Therefore, the silanes and the water have to be rapidly mixed homogeneously, which requires special mixing apparatuses.

For example, US 2009/240072 discloses a special dosage metering and mixing device for at least two liquid aqueous components that may contain organosilanes and/or organotitanates. However, the device is rather complex and causes additional costs in the production of aqueous adhesion promoter compositions.

The effect of this is that aqueous adhesion promoter compositions are generally sold as 2-component systems (e.g. Sika HydroPrep®-100 from Sika Schweiz AG) and a mixing process for the mixing of the two components is required on site prior to use. It is important that the two components are very rapidly mixed homogeneously with very significant turbulence. A specially developed piece of equipment (“shaker”) is required for the purpose. After the formulation, the ready-mixed product has a storage stability (“pot life”) of not more than 30 days.

However, this problem was addressed by special organosilane-based formulations, e.g. as taught in EP2951244. The aqueous adhesion promoter compositions disclosed therein have very good storage stability even as one-component formulations. However, it requires the addition of a specific emulsifier in order to ensure lasting homogeneity and storage stability, which is disadvantageous in terms of formulation cost and potential unwanted interactions with the adhesive or the substrate.

Another aqueous primer composition is disclosed in WO2013/116004. This composition combines both organosilanes and organotitanates, which further improves the adhesion-promoting performance on certain substrates compared to compositions based on silanes alone. However, a combination of organosilanes and organotitanates in a one-component aqueous composition creates especially demanding conditions regarding the solution storage stability, as irreversible precipitations and agglomerations of the silanes and titanates or reaction products thereof are readily observed. Only by using significant amounts of stabilizing surfactants, as taught in WO2013/116004, stable solutions with lasting transparency and no precipitations can be obtained. However, such high amounts of surfactants often lead to other problems, similar to the emulsifiers described further above, such as migration of these substances onto or into the substrate surface, interference with the adhesion process or the adhesive itself, or creating of later adhesion loss by chemical reactions within the adhesive or with the substrate.

US 2010/323203 as a further example discloses mainly solvent-based adhesion promoters containing specific organosilanes or reaction products thereof. The addition on organititanates and aqueous adhesion promoter compositions are also briefly contemplated in this document, but not elaborated in detail or shown experimentally.

So far, attempts to produce a highly storage-stable, lastingly transparent, single-component aqueous primer composition based on organosilanes and organotitanates without the requirement to use emulsifiers or surfactants have not been successful and remain desirable within the field.

### SUMMARY OF THE INVENTION

It is therefore an object of the present invention to provide a process for preparing aqueous, silane- and titanate-based adhesion-promoting primer compositions that have excellent storage stability, such that the aqueous compositions can also be sold as ready-to-use one-component aqueous adhesion promoter systems, in a simple preparation process that is possible without special mixing equipment, and without the requirement to add surfactants or emulsifiers in order to obtain a lastingly storage-stable and transparent solution without precipitations.

It has now been found that, surprisingly, achieving this object is possible by a defined stepwise approach of adding the required ingredients, thus producing a storage-stable, one-component aqueous primer composition that does not show precipitations or other deteriorations even when no emulsifier or surfactant is added and that maintains both its composition stability and its adhesion-promoting properties after prolonged storage of up to 6 months, or longer. The simple and cost-efficient process of the invention does not require special equipment and can be successfully performed using inexpensive and widely available raw materials.

The aqueous composition obtained with the process of this invention is a highly effective, adhesion-promoting primer for adhesive bonding operations, in particular when using an adhesive based on polyurethane polymers or polymers having reactive silane groups, and especially on substrates including glass or ceramics, but also on paints, metals, and plastics.

Surprisingly, the primer composition produced by the process of the invention even exceeds water-based primers of the state of the art in terms of adhesion-promoting capability, especially when the adhesive bond treated therewith is exposed to continuous heat climate.

Even more surprisingly, despite the simple preparation process without the requirement to add surfactants or emulsifiers, the obtained primer composition is highly storage stable and does not deteriorate or lose its performance even after storage for several months as one-component composition.

Accordingly, the invention relates to a process for preparing an aqueous primer composition, comprising the steps performed in consecutive order:
a) dissolving at least one organotitanate OT in a concentrated acid A preferably while stirring and optionally cooling;
b) adding water in an amount that the resulting volume ratio of (organotitanate OT and acid A) to water is between 1:2 and 1:8 and/or the resulting pH is between 2 and 5, and waiting, optionally while stirring, until a homogeneous, transparent solution is obtained;
c) adding at least one organosilane OS;
d) diluting the obtained mixture with additional water, until the resulting solution has a weight content of (organotitanate OT plus acid A plus organosilane OS) of between 1% and 5% by weight, based on the total composition, and/or the resulting solution has a pH of between 2.5 and 4.5.

It has been found that, surprisingly, it is possible with the simple process of the invention to produce stable, lastingly transparent solutions of organosilanes and organotitanates in a water-based composition that is highly suitable as primer for adhesive bonding operations. The composition obtained by the process of the invention combines all advantages of silane-titanate-based such primer compositions but does not suffer from known migration or unwanted interaction problems arising from the use of emulsifiers or surfactants. An additional, astonishing finding has been improved miscibility of the reactive components in water, which distinctly simplifies the mixing process and enables a cost-efficient, problem-free production in a standard reactor. The invention furthermore enables easier handling on application since the product can be supplied as a 1-component system and no longer as a more complicated to use 2-component system. The invention thus satisfies the demand for supply of an aqueous 1-component system with outstanding storage stability and long-lasting performance.

The aqueous composition of the invention is quite generally suitable as a reactive, invisible bonding pretreatment for substrates, especially glass and glass ceramics, or for direct glazing in automobile construction as a pretreatment for the bond, especially with polyurethane adhesives or adhesives based on silane-functional polymers including RTV silicones and organic silane-functional polymers, preferably one-component polyurethane or silane-curing adhesives.

### WAYS OF EXECUTING THE INVENTION

In the present document, the terms “silane” and “organosilane” refer to compounds that firstly have at least one hydrolyzable group, typically two or three hydrolyzable groups, preferably alkoxy groups or acyloxy groups bonded directly to the silicon atom via Si—O bonds, and secondly have at least one organic radical bonded directly to the silicon atom via a Si—C bond. Such silanes having alkoxy or acyloxy groups are also known to the person skilled in the art as organoalkoxysilanes or organoacyloxysilanes.

The silanes have the property of undergoing hydrolysis on contact with moisture. This forms organosilanols, i.e., organosilicon compounds containing one or more silanol groups (Si—OH groups) and, through subsequent condensation reactions, organosiloxanes, i.e., organosilicon compounds containing one or more siloxane groups (Si—O—Si groups).

“Epoxysilanes”, “aminosilanes” and “mercaptosilanes” refer to organosilanes wherein the organic radical respectively has an epoxy group, an amino group and a mercapto group. Organosilicon compounds having amino, mercapto or oxirane groups are also referred to as “aminosilanes”, “mercaptosilanes” or “epoxysilanes”.

“Primary aminosilanes” refer to aminosilanes having a primary amino group, i.e., an NH₂ group bonded to an organic radical. “Secondary aminosilanes” refer to aminosilanes having a secondary amino group, i.e., an NH group bonded to two organic radicals.

An Si-bonded hydrolyzable group is a group that can be hydrolyzed by hydrolysis to a silanol group, optionally in the presence of a catalyst. Hydrolysis products are silanes wherein the hydrolyzable groups have been at least partly hydrolyzed, i.e., at least some of the hydrolyzable groups have been replaced by an OH group. Condensation products include condensates of two or more hydrolyzed silanes of this kind. These hydrolysis and condensation products of silanes are known to the person skilled in the art.

The expression “independently” here always also means independently within the same molecule if there are different options.

A substance or composition is referred to as “storage-stable” or “storable” when it can be stored at room temperature in a suitable container over a prolonged period, typically over at least 3 months to up to 6 months or more, without any change in its application or use properties to a degree of relevance for the use thereof as a result of the storage.

The terms “mass” and “weight” are used synonymously in this document. Thus a “percentage by weight” (% by weight) is a percentage mass fraction which unless otherwise stated relates to the mass (the weight) of the total composition or, depending on the context, of the entire molecule.

“Room temperature” refers to a temperature of 23±2° C., especially 23° C. All industry standards and official standards mentioned in this document, unless stated otherwise, relate to the version valid at the time of filing of the first application. The invention relates in a first aspect to a process for preparing an aqueous primer composition, comprising the steps performed in consecutive order:
a) dissolving at least one organotitanate OT in a concentrated acid A preferably while stirring and optionally cooling;
b) adding water in an amount that the resulting volume ratio of (organotitanate OT and acid A) to water is between 1:2 and 1:8 and/or the resulting pH is between 2 and 5, and waiting, optionally while stirring, until a homogeneous, transparent solution is obtained;
c) adding at least one organosilane OS;
d) diluting the obtained mixture with additional water, until the resulting solution has a weight content of (organotitanate OT plus acid A plus organosilane OS) of between 1% and 5% by weight, based on the total composition, and/or the resulting solution has a pH of between 2.5 and 4.5.

The steps above have to be followed in consecutive order a) to d). It might be possible to include further steps between two respective steps, e.g., storing or transporting of the intermediate composition, or process steps such as heating, mixing, or cooling, or adding of additional ingredients.

First step a) involves dissolving at least one organotitanate OT in a concentrated acid A preferably while stirring and optionally cooling. Cooling might be necessary since dissolution of the organotitanate OT often is exothermic, which might become significant in large volume preparation batches. Stirring might not be necessary, but is recommended, especially if organotitanate OT is a highly viscous liquid and/or not readily miscible with acid A.

Stirring in step a) or any other process step can be done by simple stirring equipment, such as hand-operated stirrers or standard batch reactor stirrers. Stirring can also be done by shaking or rotating the reaction vessel or by employing other suitable homogenising equipment or operations.

Organotitante OT is in particular a water-soluble organotitanate or able to form a water-soluble titanate species under acid and/or hydrolysis conditions. Using organotitantes in primers generally leads to particularly heat-stable bonds that show excellent bonding properties even below room temperature, and generally improves the adhesion-promoting properties of the resulting primer composition especially under hot weather conditions.

Suitable amounts of organotitante OT within the final composition are preferably between 0.1% and 1% by weight, in particular between 0.2% and 0.8% by weight, most preferably between 0.3% to 0.6% by weight of organotitanate OT, based on the total weight of the aqueous composition after step d).

Suitable organotitanates OT are preferably those of the formula Ti(OR)₄, i.e. comprising substituents bonded via an oxygen-titanium bond, also including chelate substituents (polydentate ligands). Particularly suitable substituents bonded to the titanium atom via an oxygen-titanium bond are those substituents selected from the group comprising alkoxy group, sulfonate group, carboxylate group, aminoalkoxy group, dialkylphosphate group, dialkylpyrophosphate group and acetylacetonate group.

Particularly suitable compounds to be used as organotitanate OT are those in which all substituents bonded to the titanium are selected from the group comprising alkoxy group, sulfonate group, carboxylate group, aminoalkoxy group, dialkylphosphate group, dialkylpyrophosphate group and acetylacetonate group, where all substituents may be identical or different.

Particularly suitable alkoxy groups have been found to be especially methoxy, ethoxy, propoxy, isopropoxy, butoxy and isobutoxy substituents.

Most preferred organotitanates OT have substituents selected from alkoxy groups, in particular isopropoxy groups, and aminoalkoxy groups, in particular 2-(2-aminoethylamino)ethoxy groups, or mixtures of these substituents.

Suitable organotitanium compounds to be used as organotitanate OT are commercially available, for example from Kenrich Petrochemicals or DuPont. Examples of suitable organotitanium compounds are, for example, Ken-React® KR TTS, KR 7, KR 12, KR 26S, KR 33DS, KR 38S, KR 39DS, KR44, KR 134S, KR 138S, KR 158FS, KR212, KR 238S, KR 262ES, KR 138D, KR 158D, KR238T, KR 238M, KR238A, KR238J, KR262A, LICA 38J, KR 44, KR 55, LICA 01, LICA 09, LICA 12, LICA 38, LICA 44, LICA 99, KR OPPR, KR OPP2 from Kenrich Petrochemicals or Tyzor® ET, TPT, NPT, BTM, AA, AA-75, AA-95, AA-105, TE, ETAM, OGT from DuPont.

Preference is given to Ken-React® KR 7 KR 12, KR 26S, KR 38S, KR44, LICA 09, LICA 44, NZ 44, and Tyzor® ET, TPT, NPT, BTM, AA, AA-75, AA-95, AA-105, TE, ETAM from DuPont.

A most preferred organotitanate OT is 2-propanolatotris(3,6-diaza)hexanolatotitanium(IV), available under the Ken-React® KR44 trade name.

Organotitanate OT is dissolved in a concentrated acid A. “Concentrated” means that the acid A contains less than 5% by weight of water based on acid A when mixed with organotitanate OT. Higher amounts of water could lead to unwanted side reactions and/or inhibit the full dissolution, possibly involving ligand exchange reactions, of the organotitanate complex. For acetic acid, being especially preferred as acid A, it is preferred to use a purity of at least 96%, preferably at least 99%.

Acid A is in particular a water-soluble or fully water-miscible acid. The amount of acid A is selected such that organotitanate OT is fully dissolved therein. Without using an acid A, it is not possible in this process of the invention to eventually obtain a stable composition having acceptable storage stability without showing turbidity and precipitates.

A suitable amount of acid A within the final composition after step d) is preferably between 1% and 7.5% by weight, in particular between 2% and 5% by weight, based on the total composition after step d). Acid A may be added after step a) to adjust the pH of the composition at any process step. For example, when using aminosilanes as organosilane OS, as described further below, their amino groups influence the pH of the composition. Especially when using large amounts of such aminosilanes, additional acid A might need to be added in order to adjust the pH to the desired range.

Typical amounts of acid A for dissolving organotitanate OT and optionally the adjustment of the pH to the desired range depend of course on the acid used and its strength. For carboxylic acids, especially acetic acid, a suitable amount is typically between 2% and 5% by weight, based on the overall composition after step d).

Acid A may be organic or inorganic. Organic acids A are firstly carboxylic acids, especially a carboxylic acid selected from the group comprising formic acid, acetic acid, propionic acid, trifluoroacetic acid, oxalic acid, malonic acid, succinic acid, maleic acid, fumaric acid and citric acid, and amino acids, especially aspartic acid and glutamic acid. A preferred carboxylic acid is acetic acid.

Organic acids A are secondly especially those containing a sulfur atom. Such organic acids are especially organic sulfonic acids. Organic sulfonic acid is understood to mean compounds that have an organic radical having carbon atoms and have at least one functional group —SO₃H. Preference is given to aromatic sulfonic acids.

The aromatic sulfonic acid may be mono- or polycyclic, and one or more sulfo groups may be present. For example, this may be naphthalene-1- or -2-sulfonic acid, naphthalene-1,5-disulfonic acid, benzenesulfonic acid or alkylbenzenesulfonic acids.

The acid A may also be an inorganic acid. Suitable inorganic acids A are, for example, those that have a sulfur atom or a phosphorus atom. Acids having phosphorus atoms are especially phosphoric acid, phosphorous acid, phosphonic acid, phosphonous acid. Acids having sulfur atoms are especially sulfur acids, especially sulfuric acid, sulfurous acids, persulfuric acid, disulfuric acid (=pyrosulfuric acid), disulfurous acid, dithionic acid, dithionous acid, thiosulfuric acid or thiosulfurous acid.

Preference is given to acids A having a pKₐ between 4.0 and 5. pKₐ is understood by the chemist in a known manner to mean the negative decadic logarithm of the acid dissociation constant Kₐ: pKₐ=−log₁₀Kₐ.

Most preferred acid A is a carboxylic acid, especially acetic acid.

Step a) can be performed fairly quickly and the reaction is usually completed after spontaneous initiation upon mixing of acid A and organotitanate OT within 10-15 min. In case a significant exothermicity is observed, cooling with standard technical means might be advisable. Too high heat generation is generally to be avoided in order to prevent safety issues or undesired side reactions. Furthermore, step a) may need to be performed using appropriate safety equipment such as closed reaction vessels and/or ventilation, since fumes of acid A may be formed that may have detrimental health effects or may act as corrosive on metallic equipment.

Once step a) is completed, step b) can be initiated, i.e., adding water in an amount that the resulting volume ratio of (organotitanate OT and acid A) to water is between 1:2 and 1:8 and/or the resulting pH is between 2 and 5, and waiting, optionally while stirring, until a homogeneous, transparent solution is obtained.

It has been found that high dilutions of the product of step a) with water, using a volume ratio of (organotitanate OT and acid A) to water of above 1:8, leads to undesired opalescence and precipitations within the solution when in step c) the organosilanes OS are added.

Equally, a too low volume ratio of (organotitanate OT and acid A) to water of below 1:2 on the other hand leads to irreversible gelation and the formation of a transparent gel within the diluted reaction mixture when in step c) the organosilanes OS are added. Both these states have to be avoided. In general, a volume ratio of (organotitanate OT and acid A) to water of between 2.5 and 7.5, especially between 3 and 6, preferably between 3.5 and 5, and most preferably about 4 has been found to be ideal after completion of step b). When working with such a dilution, addition of organosilanes OS in step c) forms clear, transparent solutions that may be colourless or slightly yellowish or reddish.

During step b), i.e. the addition of water and the hydrolysis of the organotitanate species present, it is possible that the solution may temporarily become hazy or slightly turbid, and even a temporary formation of precipitates may occur. However, after short equilibration time, preferably while stirring, the precipitations and inhomogeneities disappear and a permanently transparent solution is formed. This normally happens within 10-15 min or less.

The resulting pH of the water-diluted composition after step b) is preferably between 2 and 5, in particular between 2.5 and 4.5. It is recommended to measure the pH at this stage, e.g. by using a pH-meter or pH indicator paper, and adjust the pH within the range just specified by further addition of acid A or further dilution, if required. It is advantageous to adjust the pH within the specified range before the organosilanes OS are added, in order to minimize the risk of unwanted reactions, in particular silane condensation.

Water to be used in step b) and step d) is preferably deionized water, in particular either obtained by distillation or by reverse osmosis using common such processes known in the art.

Step b) can be done in a very easy manner and is completed in minutes. Preferably, some stirring or shaking may be employed to ensure a homogeneous mixing and the quick disappearance of possibly present temporary precipitations as described above.

After completion of step b), step c) in performed, i.e., the addition of organosilane OS.

Organosilanes OS added in step c) to the composition each have at least one Si-bonded hydrolyzable group that may already initially be partially or fully hydrolyzed. These may be any customary hydrolyzable groups, preference being given to alkoxy groups and acyloxy groups, and particular preference to C₁-C₄-alkoxy groups. After mixing with water, the hydrolyzable groups can be hydrolyzed with time. The result in that case is hydrolysis products in which at least some of the hydrolyzable groups are replaced by OH groups (silanol groups). As a further reaction, condensation products may form via the silanol groups formed in the hydrolysis products. For instance, the organosilanes present may also be in fully hydrolyzed or partly hydrolyzed or even partly condensed form.

Particularly suitable organosilanes OS are organosilicon compounds of the formulae (I) or (II) or (Ill)

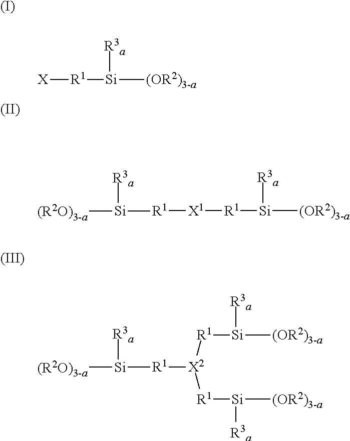

R¹ here is a linear or branched, optionally cyclic alkylene group having 1 to 20 carbon atoms, optionally having aromatic moieties, and optionally having one or more heteroatoms, especially nitrogen atoms.
R² here is H or an alkyl group having 1 to 5 carbon atoms, especially methyl or ethyl, or an acyl group, especially acetyl.
R³ here is an alkyl group having 1 to 8 carbon atoms, especially methyl.
X here is H, or is a functional group selected from the group comprising OH, (meth)acryloyloxy, mercapto, glycidoxy, epoxy, primary amine, alkylamine comprising primary and secondary amino groups, secondary alkyl or arylamine, acylthio and vinyl, preferably amine in all forms as described before. For the sake of completeness, it is mentioned that acylthio in this document is understood to mean the substituent

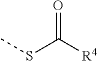

where R⁴ is alkyl, especially having 1 to 20 carbon atoms, and the dotted line represents the bond to the substituent R¹.
X¹ here is a functional group selected from the group comprising NH, S, S₂ and S₄.
X² here is a functional group selected from the group comprising N and isocyanurate.
a here represents one of the values 0, 1 and 2, preferably 0.

The substituent R¹ is especially a methylene, propylene, methylpropylene, butylene or dimethylbutylene group. As particularly preferred is propylene group as substituent R¹.

Examples of suitable organosilicon compounds of the formula (I) are the organosilicon compounds selected from the group comprising
octyltrimethoxysilane, dodecyltrimethoxysilane, hexadecyltrimethoxysilane, methyloctyldimethoxysilane;
3-methacryloyloxypropyltrialkoxysilanes, 3-methacryloyloxypropyltriethoxysilane, 3-methacryloyloxypropyltrimethoxysilane;
3-aminopropyltrimethoxysilane, 3-aminopropyltriethoxysilane, 3-aminopropyldimethoxymethylsilane, 3-amino-2-methylpropyltrimethoxysilane, N-(2-aminoethyl)-3-aminopropyltrimethoxysilane, N-(2-aminoethyl)-3-aminopropyltriethoxysilane, N-(2-aminoethyl)-3-aminopropyldimethoxymethylsilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, [3-(2-aminoethylamino)propyl]trimethoxysilane (=4,7,10-triazadecyltrimethoxysilane), 2-aminoethyltrimethoxysilane, 2-aminoethyldimethoxymethylsilane, aminomethyltrimethoxysilane, aminomethyldimethoxymethylsilane, aminomethylmethoxydimethylsilane, 7-amino-4-oxaheptyldimethoxymethylsilane, N-(methyl)-3-aminopropyltrimethoxysilane, N-(n-butyl)-3-aminopropyltrimethoxysilane;
3-acylthiopropyltrimethoxysilane;
vinyltrimethoxysilane and vinyltriethoxysilane.

Also preferred are the organosilicon compounds just mentioned wherein the alkoxy groups are replaced by acetoxy groups, for example octyltriacetoxysilane (octyl-Si(O(O═C)CH₃)₃). Such organosilicon compounds eliminate acetic acid on hydrolysis.

Among these organosilicon compounds mentioned, preference is given to those that have an organic substituent bonded to the silicon atom which additionally have a functional group, i.e. which is not an alkyl group, and conform to a formula (I) in which X is not H.

Suitable examples of organosilicon compounds of the formula (II) are the organosilicon compounds selected from the group comprising bis[3-(trimethoxysilyl)propyl]amine, bis[3-(triethoxysilyl)propyl]amine, 4,4,15,15-tetraethoxy-3,16-dioxa-8,9,10,11-tetrathia-4-15-disilaoctadecane (bis(triethoxysilylpropyl) polysulfide or bis(triethoxysilylpropyl)tetrasulfane), bis(triethoxysilylpropyl) disulfide.

Suitable examples of organosilicon compounds of the formula (III) are the organosilicon compounds selected from the group comprising tris[3-(trimethoxysilyl)propyl]amine, tris[3-(triethoxysilyl)propyl]amine, 1,3,5-tris[3-(trimethoxysilyl)propyl]-1,3,5-triazine-2,4,6(1H,3H,5H)-trioneurea (=tris(3-(trimethoxysilyl)propyl) isocyanurate) and 1,3,5-tris[3-(triethoxysilyl)propyl]-1,3,5-triazine-2,4,6(1H,3H,5H)-trioneurea (=tris(3-(triethoxysilyl)propyl) isocyanurate).

Optionally, the composition may also comprise at least one tetraalkoxysilane of the formula (IV)

Si(OR⁴)₄ (IV)
where R⁴ is independently an alkyl group having 1 to 4 carbon atoms or an acyl group, especially acetyl group. Such tetraalkoxysilanes are, for example, tetramethoxysilane, tetraethoxysilane, tetraisopropoxysilane, tetrapropoxysilane, tetrabutoxysilane and tetraacetoxysilane. Particular preference is given to tetraethoxysilane. As in the case of the aminosilanes and mercaptosilanes, tetraalkoxysilanes can undergo hydrolysis in the presence of water and optionally condense with other silanes.

Organosilane OS preferably comprises at least one organosilane or condensate thereof that has at least one Si-bonded hydrolyzable group and has at least one primary and/or secondary amino group, and which during step c) preferably is added after optionally used further organosilanes OS having no alkaline functional groups. This sequence of addition is most advantageous, since the aminosilanes can have an effect on the pH and make it more difficult to properpyl solubilize the further organosilanes OS when added before those. However, it is often also possible to add all silanes simultaneously in the form of a silane premix. These further organosilanes OS are in particular organosilanes or oligomers of these organosilanes that have at least one Si-bonded hydrolyzable group and have at least one further functional group selected from alkyl groups, alkylene groups, epoxy groups, mercapto groups, hydroxyl groups and isocyanurate groups, including the mercaptosilanes and epoxysilanes described below.

Preferred as organosilanes OS are aminosilanes, especially aminosilanes with X═NH₂ or NH₂—CH₂—CH₂—NH, X¹═NH and X²═N. Particular preference is given to 3-aminopropyltrimethoxysilane, N-(2-aminoethyl)-3-aminopropyltrimethoxysilane, bis[3-(trimethoxysilyl)propyl]amine, 3-aminopropyltriethoxysilane, N-(2-aminoethyl)-3-aminopropyltriethoxysilane and bis[3-(triethoxysilyl)propyl]amine and mixtures thereof with one another.

Suitable aminosilanes as organosilane OS are especially aminosilanes selected from the group consisting of 3-aminopropyltrimethoxysilane, 3-aminopropyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane, aminomethylmethoxydimethylsilane, N-methyl-3-aminopropyltrimethoxysilane, N-ethyl-3-aminopropyltrimethoxysilane, N-butyl-3-aminopropyltrimethoxysilane, N-cyclohexyl-3-aminopropyltrimethoxysilane, N-phenyl-3-aminopropyltrimethoxysilane, N-methyl-3-amino-2-methylpropyltrimethoxysilane, N-ethyl-3-amino-2-methylpropyltrimethoxysilane, N-ethyl-3-aminopropyldimethoxymethylsilane, N-phenyl-4-aminobutyltrimethoxysilane, N-phenylaminomethyl-dimethoxymethylsilane, N-cyclohexylaminomethyldimethoxymethylsilane, N-methylaminomethyldimethoxymethylsilane, N-ethylaminomethyldimethoxy-methylsilane, N-propylaminomethyldimethoxymethylsilane, N-butylamino-methyldimethoxymethylsilane; N-(2-aminoethyl)-3-aminopropyltrimethoxysilane, 3-[2-(2-aminoethylamino)ethylamino]propyltrimethoxysilane, bis(trimethoxysilylpropyl)amine, and analogs thereof having three ethoxy or three isopropoxy groups rather than the three methoxy groups on the silicon.

In one embodiment, the aminosilane of the formula (I) is an aminosilane of the formula (V)

H₂N—R⁵—S(OR₂)₍₃₋ₐ₎(R)ₐ (V)
where R⁵ is a linear or branched alkylene group having 1 to 6 carbon atoms, especially propylene, and the other substituents and indices are as defined in formula (I). Particular preference is given here to 3-aminopropyltrimethoxysilane.

In a preferred embodiment, the aminosilane of the formula (I) has secondary amino groups, especially aminosilanes of the formula (VI) or (VII) or (VIII).

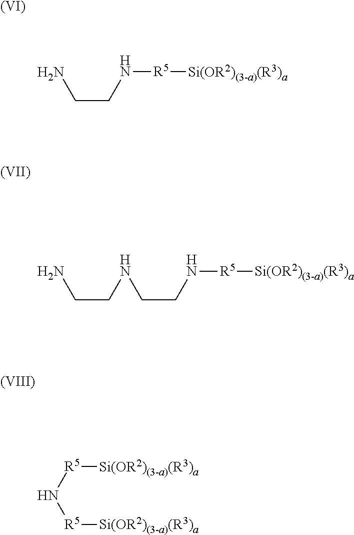

where R⁵ is a linear or branched alkylene group having 1 to 6 carbon atoms, especially propylene, and the other substituents and indices are as defined in formula (I). N-(2-Aminoethyl)-3-aminopropyltrimethoxysilane, 3-[2-(2-aminoethylamino)ethylamino]propyltrimethoxysilane and bis(trimethoxysilylpropyl)amine have been found to be particularly preferable as organosilane OS.

It has been found to be particularly advantageous when two or more aminosilanes of the formula (I) are present in the composition as organosilane OS, of which preferably at least one is an aminosilane of the formula (VI). A particularly preferred combination within organosilane OS is an aminosilane of the formula (VI) and an aminosilane of the formula (VIII) in the composition.

In one or more embodiments, the at least one aminosilane is present in the composition of the invention after step d) in an amount of 0.2% to 2.5% by weight, preferably 0.25% to 2.25% by weight, especially preferably in an amount of 0.5% to 2% by weight, based on the overall composition after step d).

Organosilane OS comprises in preferred embodiments at least one epoxysilane. An epoxysilane suitable as organosilane OS has at least one epoxy group, for example a glycidoxy group, and at least one Si-bonded hydrolyzable group. The epoxy group is preferably a glycidoxy or epoxycyclohexyl group, especially a glycidoxy group.

Preferred epoxysilanes are (epoxyalkoxy)alkyltrialkoxysilanes and 3-glycidoxypropyltrialkoxysilanes. Particular preference is given to gamma-glycidoxypropyltrimethoxysilane. Preferred representatives of these substance classes are beta-(3,4-epoxycyclohexyl)ethyltrimethoxysilane and beta-(3,4-epoxycyclohexyl)ethyltriethoxysilane, and also 3-glycidoxypropyltrimethoxysilane and/or 3-glycidoxypropyltriethoxysilane. More preferably, 3-glycidoxypropyltrimethoxysilane and/or 3-glycidoxypropyltriethoxysilane are used as organosilane OS.

In one or more embodiments, the at least one epoxysilane is present in the composition of the invention after step d) in an amount of 0.1% to 2% by weight, preferably 0.15% to 1.5% by weight, especially preferably in an amount of 0.2-0.1% by weight, based on the overall composition after step d).

Organosilane OS comprises in preferred embodiments at least one mercaptosilane. A mercaptosilane suitable as organosilane OS has at least one mercapto group, for example a mercaptopropyl groups, and at least one Si-bonded hydrolyzable group, and is preferably a mercapto-functional organoalkoxysilane, i.e. mercaptosilane that bears a C1 to C4 alkoxy group on the hydrolyzable silane group. Particular preference is given to mercapto-functional organomethoxysilanes and mercapto-functional organoethoxysilanes. Mercaptosilanes having three alkoxy groups, especially three methoxy groups, have been found to be particularly advantageous.

Particularly preferred mercaptosilanes are 3-mercaptopropyltrimethoxysilane and 3-mercaptopropyltriethoxysilane and 3-mercaptopropylmethyldimethoxysilane, especially 3-mercaptopropyltrimethoxysilane and 3-mercaptopropyltriethoxysilane, more preferably 3-mercaptopropyltrimethoxysilane.

However, it is also possible to use mercaptosilanes having multiple mercapto and/or multiple silane groups as organosilane OS.

In one or more embodiments, at least one mercaptosilane is present in the composition of the invention after step d) in an amount of 0.1% to 2% by weight, preferably 0.15% to 1.5% by weight, especially preferably in an amount of 0.2-0.1% by weight, based on the overall composition after step d).

If organosilane OS is a mixture of different organosilanes, and if these organosilanes are not sensitive to cross reactions with each other, they may be premixed and added together in step c).

In especially preferred embodiments of the inventive process, in step c) at least one mercaptosilane and at least one aminosilane are added. This combination has especially beneficial adhesion-promoting properties while it is especially storage-stable.

By contact with water, organosilanes OS are slowly or quickly hydrolyzed during step c). Even in the best optimized procedure conditions, transient precipitation may occur, and the solution may turn slightly turbid, if the pH is correctly adjusted however, especially in the range of between 2 and 5, this incipient precipitation can be reversed completely in a short time (typically <10 min) and the solution becomes permanently transparent.

The last step, d), is diluting the obtained mixture of step c) with additional water, until the resulting solution has a weight content of (organotitanate OT plus acid A plus organosilane OS) of between 1% and 10% by weight, preferably between 2% and 8% by weight, more preferably between 3% and 6% by weight, based on the total composition, and/or the resulting solution has a pH of between 2.5 and 4.5. Within this concentration range the primer composition is most stable and shows an optional performance. Also, within this pH range, the solution has the best stability against unwanted precipitation or gelation.

The composition obtained by the process of the invention preferably does not contain wetting agents, surfactant, or emulsifiers. Such substances are not required for the preparation and omission thereof decreases production costs and leads to better and longer-lasting adhesion-promoting performance, especially under heat conditions and hot weathering (sun light, UV light) conditions.

Thus, in preferred embodiments of the process of the invention, no surfactants and no emulsifiers are added to the composition at any step.

Accordingly, in preferred embodiments of the composition obtained by the process of the invention, the composition contains no surfactants and no emulsifiers after completion of the process.

However, in some embodiments it might be advantageous to include such additives, in particular when using highly hydrophobic organosilanes OS or other ingredients with poor water-solubility or -miscibility. Such additives are preferably nonionic wetting agents. A “nonionic wetting agent” is understood to mean all substances that are not predominantly in ionic form in water and are capable of lowering the surface tension of water and/or enable the stabilization of emulsions. These include nonionic surfactants, surface-active substances, emulsifiers and similar substances that have these properties.

The suitable nonionic surfactants include, for example, ethoxylates, for example ethoxylated addition products of alcohols, for example polyethers, glycol ethers, polyoxyalkylenepolyols, amines, fatty acids, fatty acid amides, alkylphenols, ethanolamides, fatty amines, polysiloxanes, polyethersiloxanes or fatty acid esters, but also alkyl or alkylphenyl polyglycol ethers, for example fatty alcohol polyglycol ethers, or fatty acid amides, alkyl glycosides, sugar esters, sorbitan esters, polysorbates or trialkylamine oxides, but also esters and amides of poly(meth)acrylic acids with polyalkylene glycols or amino polyalkylene glycols, which may be terminated by alkyl groups at one end at most.

Such surfactants are widely commercially available. Particularly suitable are alkoxylated alcohols, alkoxylated nonionic fluorosurfactants, especially Zonyl® FSO-100, which is commercially available from ABCR, Germany, alkoxylated alcohols or alkoxylated alkyl phenols, especially Antarox FM 33, which is commercially available commercially from Rhodia. In addition, preference is given to alkoxylated fatty alcohols, such as Hydropalat® 120 from Cognis. Particular preference is given to using Hydropalat® 3037 from Cognis as nonionic wetting agent. Also very preferred are polyethers, especially short-chain polyethers having molar masses up to 300 g/mol, especially up to 205 g/mol, preferably up to 200 g/mol, for example glycol ethers. Preferred polyethers are polypropylene glycols, polyethylene glycols and triethylglycol dimethyl ether (“triglyme”), bis(2-methoxyethyl) ether (“diglyme”) and, most preferably, 2,5,7,10-tetraoxaundecane.

The suitable emulsifiers especially also include those selected from pyrrolidones, propionamides and amino alcohol reaction products. Pyrrolidones are cyclic carboxamides; propionamides are linear carboxamides. Amino alcohols are used as an integrated emulsifier in the form of a reaction product having at least a portion of the aminosilane and/or mercaptosilane in the composition. Preference is given to the use of pyrrolidones or amino alcohol reaction products. The emulsifiers bring about better miscibility with water and slowed condensation reactions after addition of water.

The usable pyrrolidones are especially 2-pyrrolidones. 2-Pyrrolidones are cyclic carboxamides. The usable pyrrolidones may be 2-pyrrolidone, also referred to as γ-butyrolactam, or a derivative of 2-pyrrolidone having a substituent on at least one of the three methylene ring groups and/or on the nitrogen atom. Suitable substituents on the nitrogen atom are alkyl, e.g. C₁₋₁₂-alkyl, preferably C₁-C₇-alkyl, more preferably C₁-C₄-alkyl, especially methyl or ethyl, or cycloalkyl, preferably cyclopentyl and cyclohexyl, especially cyclohexyl. Suitable substituents on the methylene group are, for example, alkyl, preferably C₁-C₄-alkyl, especially methyl or ethyl.

Preference is given to N-substituted 2-pyrrolidones. They may optionally have a substituent on at least one methylene ring group, but this is not preferred. Examples are N—C₁-C₁₂-alkyl-2-pyrrolidone and polyvinylpyrrolidone. Examples of compounds having longer-chain alkyl groups are 1-octyl-2-pyrrolidone and 1-dodecylpyrrolidone. Particular preference is given to N—C₁-C₇-alkyl-2-pyrrolidone or N—C₁-C₆-alkyl-2-pyrrolidone, especially N—C₁-C₄-alkyl-2-pyrrolidone, and N-cycloalkyl-2-pyrrolidone, such as N-cyclohexyl-2-pyrrolidone. Most preferred are N-methyl-2-pyrrolidone (NMP), N-ethyl-2-pyrrolidone (NEP) and especially N-cyclohexyl-2-pyrrolidone (CHP).

Suitable propionamides are propionamide itself and derivatives of propionamide. Examples of suitable propionamides are propionamides of the formula

R⁶—C(O)NR⁷₂
in which R⁶ is a substituted or unsubstituted ethyl group and R⁷ is independently H or a C₁₋₄-alkyl group, especially methyl or ethyl. Preferably, at least one R⁷ group is a C₁₋₄-alkyl group and, more preferably, both R⁷ groups are a C₁₋₄-alkyl group, preference being given to the methyl and ethyl group.

Specific examples are 3-methoxy-N,N-dimethylpropionamide and 3-butoxy-N,N-dimethylpropionamide.

The amino alcohol with which the amino alcohol reaction product is formed is a compound having at least one amino group and at least one hydroxyl group. The amino alcohol may have one or two hydroxyl groups, for example, preference being given to one hydroxyl group. The amino alcohol may have one or two or more amino groups, for example, where the amino groups may, for example, be primary or secondary amino groups.

Examples of amino alcohols suitable as emulsifier precursor for preparation of the amino alcohol reaction product are ethanolamine, diethyleneglycolamine, N—(β-aminoethyl)aminoethanol, diethanolamine and N-methyldiethanolamine, most preferably diethyleneglycolamine. Diethyleneglycolamine is also referred to as 2-(2-aminoethoxy)ethanol.

In preferred embodiments, the at least one nonionic wetting agent present is selected from emulsifiers or surfactants from the group of polyethers, polyethersiloxanes, pyrrolidones and modified natural oils.

In a first preferred main embodiment, the composition after step d) comprises at least 90% by weight, based on the total composition, of water, and, each based on the total weight of the aqueous composition, respectively:
0.2% to 0.6% by weight of organotitanate OT,
0.25% to 2% by weight of at least one aminosilane,
0.2% to 1% by weight of at least one mercaptosilane and/or epoxysilane, and
2% to 5% by weight of acid A.

In an especially preferred embodiment of this composition, the composition consists of the listed substances and contains as much water that all percentages add up to 100%.

The one-component or multicomponent composition may comprise further optional constituents. Such additional constituents are, for example, anionic, cationic or amphoteric surfactants, adhesion promoter additives, catalysts, cosolvents, biocides, antisettling agents, stabilizers, inhibitors, pigments, dyes, anticorrosives, odorants, UV indicators, thixotropic agents, fillers, defoamers and further additives known to the person skilled in the art in the field of aqueous adhesion promoter compositions.

A further optional constituent used with preference is a water-soluble adhesion promoter additive, preferably a water-soluble amine-containing adhesion promoter additive. The use of water-soluble adhesion promoter additives generally improves bonding performance. Water-soluble adhesion promoter additives are commercially available.

Examples of suitable water-soluble adhesion promoter additives are reactive organofunctional siloxane oligomers. Examples are condensed aminosiloxanes and/or phenylsiloxanes. The degree of condensation of the siloxanes may be different. The siloxanes may be dimers, trimers or oligomers composed of four or more monomeric silanes or mixtures thereof. Such siloxanes, especially aminosiloxanes, are also commercially available, for example as Dynasylan® HYDROSIL 2627, Dynasylan® HYDROSIL 2776 or Dynasylan® HYDROSIL 2929 from Degussa AG, Germany.

Cosolvents are understood to mean water-miscible solvents such as alcohols or ethers or ketones. However, it is preferable that such solvents are used only in a small amount, i.e. typically less than 10% by weight based on the water. More preferably, the composition—apart from traces of alcohols that result from the hydrolysis of the alkoxysilanes used in the aqueous composition—is free of such cosolvents. If a greater content of solvent is used, the VOC problem is increased in turn, the avoidance of which is of course one of the main reasons for the use of aqueous compositions.

The composition may be a one-component or two-component aqueous adhesion promoter composition, more preferably a one-component aqueous adhesion promoter composition.

In the preferred one-component aqueous primer composition, the above-described organosilane OS, organotitanate OT, acid A, water, and optional further ingredients are present in the sole component, which is obtained after step d) of the inventive process. The two-component aqueous adhesion promoter composition consists of a composition after step c) of the inventive process, which is then diluted with water (and optional further ingredients) to perform step d). The one-component aqueous adhesion promoter composition is notable for excellent storage stability.

The one- or two-component aqueous primer composition of the invention is especially suitable as adhesion promoter or primer, preferably as primer for adhesives and sealants. The use of such a primer improves the adhesive bond.

The adhesive used may in principle be any adhesive. Advantageous improvements in adhesion are found especially in the case of polyurethane adhesives, especially those containing polyurethane prepolymers having isocyanate groups, and of adhesives based on silane-functional polymers. Such polyurethane adhesives are widely commercially available, for example Sikaflex® from Sika Schweiz AG. The aqueous composition of the invention is particularly suitable for 1K (one-component) polyurethane adhesives.

A suitable method for bonding or sealing two or more substrates is thus one in which the aqueous primer composition of the invention is applied to at least one substrate as a pretreatment and flashed off. Subsequently, the substrates are bonded or sealed with an adhesive or sealant, preferably a 1K polyurethane adhesive.

The primer compositions can be used in various ways. In a particularly preferred embodiment, they are a primer or an adhesion-promoting undercoat.

In a further aspect, the present invention relates to a method of bonding or of sealing.

This method comprises the following steps:
i) applying a primer composition as described above to a substrate S1 to be bonded or sealed
ii) applying an adhesive or sealant to the composition present on the substrate S1
iii) contacting the adhesive or sealant with a second substrate S2;
   or
i′) applying a primer composition as described above to a substrate S1 to be bonded or sealed
ii′) applying an adhesive or sealant to the surface of a second substrate S2
iii′) contacting the adhesive or sealant with the composition present on the substrate S1;
   or
i″) applying a primer composition as described above to a substrate S1 to be bonded or sealed
ii″) applying an adhesive or sealant between the surfaces of substrates S1 and S2.

The second substrate S2 here consists of the same material as the substrate S1 or a different one.

Typically, step iii), iii′) or ii″) is followed by a step iv) of curing the adhesive or sealant. The adhesive or sealant used may in principle be any adhesive or sealant. The selection is guided by factors including the open time and the mechanical demands on the bond formed. It has been found that this method is of especially good suitability for polyurethane adhesives or sealants, especially for polyurethane adhesives containing at least one polyurethane prepolymer having isocyanate groups. Such polyurethane adhesives cure under the influence of air humidity via a crosslinking reaction of isocyanate groups and are widely commercially available, especially under the Sikaflex® name from Sika Schweiz AG.

Prior to step ii), ii′) or ii″), there may be at most a wiping-off step with a dry cloth. The ever-present application by means of a soaked cloth or a similar method is referred to as “wipe-on”. Correspondingly, the combination of application and wiping-off is referred to as “wipe-on/off”.

With the application of the adhesive or sealant, it is possible to wait until the primer composition has flashed off. However, it has been found that, astonishingly, application of the adhesive or sealant is in most cases also possible directly to the still-moist primer composition film, i.e. “wet-on-wet”, without this having any notable disadvantages in the adhesion or mechanical properties of the cured sealant or adhesive.

The substrate S1 may be the same as or different than substrate S2.

Suitable substrates S1 or S2 are, for example, inorganic substrates such as glass, glass ceramic, concrete, mortar, brick, tile, gypsum and natural rocks such as granite or marble; metals or alloys such as aluminum, steel, nonferrous metals, precious metals such as silver, galvanized metals; organic substrates such as wood, plastics such as PVC, polycarbonates, PMMA, polyesters, epoxy resins; coated substrates such as powder-coated metals or alloys; and paints and lacquers. Especially preferred as substrates S1 or S2 are glass, glass ceramic, screen-print or silver print on glass or glass ceramic, aluminium and lacquers, especially in the form of automotive paint. The substrates can be pretreated if required prior to the application of the adhesive or sealant. Pretreatments of this kind especially include physical and/or chemical cleaning methods, for example sanding, sandblasting, brushing or the like, or treatment with detergents or solvents, or the application of an adhesion promoter, an adhesion promoter solution or a primer.

Such a method of bonding or sealing results in an article. Since the method can be used widely, for example in industrial manufacture or in civil engineering or structural engineering, the nature of this article is also very varied.

More particularly, this article is a built structure, an industrial good or a mode of transport. More particularly, it is a building, or a part thereof. Or the article is especially a mode of transport, especially an automobile, bus, truck, rail vehicle, ship or aircraft.

The aqueous primer composition of the invention is particularly suitable as pretreatment for bonding of glass panes, especially in vehicle construction, or for direct glazing.

Therefore, in a preferred embodiment, one substrate is glass or glass ceramic, and the second substrate is a lacquer or a painted metal or a painted metal alloy.

The use of mercaptosilanes in the aqueous primer composition leads to a significant improvement in adhesion of 1K polyurethane adhesives on silver or on silver-based compositions or alloys. It has been found that the method described is of especially good suitability for bonding of glass panes with an integrated antenna or other electronic components. Such antenna contacts or other electronic components are present on the pane and typically composed of silver or of silver-based compositions or alloys.

### EXAMPLES

The invention is elucidated further by examples which follow, but these are not intended to limit the invention in any way.

### Raw Materials Used

The following raw materials listed in Table 1 were used as commercially obtained without further purification or modification and employed in the process according to the invention to produce example primer compositions to demonstrate the effect of the invention.

TABLE 1
Raw materials used.

| | |
|---|---|
| Sil A1120 | N-(2-Aminoethyl)-3-aminopropyltrimethoxysilane |
| | Silquest ® A1120, Momentive Performance Materials |
| Sil A1170 | Bis(trimethoxysilylpropyl)amine |
| | Silquest ® A1170, Momentive Performance Materials |
| Sil A189 | 3-Mercaptopropyltrimethoxysilane |
| | Silquest ® A189, Momentive Performance Materials |
| KR 44 | Titanate; 2-propanolato, tris(3,6-diaza)hexanolato |
| | titanium(IV), Ken-React ® KR 44, Kenrich Petrochemicals |
| Acetic acid | Acetic acid, 99% |
| Dispex | surfactant; modified natural oil, free of |
| | silicone, Dispex ® Ultra FA 4437, BASF |
| Byk-349 | surfactant; polyether-modified siloxane, |
| | BYK ®-349, BYK Chemie GmbH |
| Water | Deionised water |

### Production of the Example Composition C1

Example composition C1 was produced using the following procedure in consecutive order and involving the raw materials listed in Table 1:

### Step a)

2.4 g of KR 44 were dissolved in 18 g of acetic acid under stirring and cooling and left for KR 44 to fully dissolve in acetic acid for 15 min. This resulted in a yellow-orange, transparent liquid solution.

### Step b)

The obtained solution was diluted with 45 g of water and mixed until homogeneous during 15 min.

### Step c)

A premix of organosilanes OS was added slowly under stirring, said premix consisting of 5.13 g of Sil A1170, 0.72 g of Sil A1120, and 1.35 g of Sil A189. The mixture temporarily turned turbid, but after 10 min, a clear solution with and orange taint was obtained.

### Step d)

The solution was then diluted with 527.4 g of water to the final primer composition, resulted in a clear, slightly yellowish, fully transparent solution.

The product of step d) is the final primer composition C1.

Composition C1 was then filled into glass containers and used as primer for adhesion tests. Within the closed glass bottle, primer C1 remained transparent without any precipitations or other optical or other noticeable changes for at least 6 months of storage at room temperature, after which monitoring storage stability at room temperature was discontinued. A simulated ageing test for prolonged storage stability was performed as well by placing a sealed glass container of primer C1 in an oven at 50° C. After 6 months at 50° C., no precipitations or other changes were observed, after which monitoring storage stability under simulated ageing conditions (heat) was discontinued. Furthermore, an adhesion test with the aged samples (6 months at room temperature or 50° C.) showed virtually no drop in adhesion-promoting performance compared to a fresh sample of the same primer.

### Production of the Example Composition C2

Example composition C2 was produced exactly as composition C1 described above, with the difference that in step a), additionally 2.82 g of Dispex and 0.6 g of Byk-349 were added.

### Production of the Example Composition C3 (Reference Example)

Example composition C3 was produced exactly as composition C1 described above, with the difference that in step a), additionally 2.82 g of Dispex and 0.6 g of Byk-349 were added, but addition of KR 44 was omitted. Composition C3 is not according to the invention since it does not contain organotitanate OT.

### Production of the Example Composition C4 (Reference Example)

Example composition C4 was produced using the same ingredients as C1 described above, with the only difference that in step b) only 30 g of water were added (corresponding to a volumetric volume ratio of (organotitanate OT and acid A) to water of <1:2). After addition of premix of organosilanes OS in step d) the composition turned into a persistent transparent gel and could not be further used in adhesion tests.

### Production of the Example Composition C5 (Reference Example)

Example composition C5 was produced using the same ingredients as C1 described above, with the only difference that in step b) 180 g of water were added (corresponding to a volumetric volume ratio of (organotitanate OT and acid A) to water of >1:8). After addition of premix of organosilanes OS in step d) the composition became persistently opalescent and visible precipitations were formed. This example composition could not be used for adhesion tests.

### Production of the Example Composition C6 (Reference Example)

Example composition C6 was produced using the same ingredients in the same amounts as in C1 described above, with the only difference that 2.4 g of KR 44 (organotitanate OT) were not added in step a), but instead directly after the addition of the premix of organosilanes OS in step d). The result was that the composition was not able to dissolve organotitanate OT at this stage even under strong stirring, and a turbid, inhomogeneous mixture was obtained that would not homogenize even after prolonged stirring and storage. This example composition could not be used for adhesion tests.

Reference examples C4 to C6 show that the process according to the invention has to be followed closely in order to obtain an aqueous primer composition according to the invention. Any deviation of the defined process steps and their consecutive order leads to inferior results, including unstable or inhomogeneous mixtures or even complete deterioration by gelation.

### Testing Protocols

The aqueous primer composition C1 was tested for initial adhesion-promoting performance and the adhesion heat stability of the adhesive bonds on various substrates as adhesion promoter in combination with various adhesives. Aqueous primer compositions C2 and C3 (reference) were also tested for adhesion heat stability in comparison.

As comparative reference representing the state of the art in the test protocol, a commercial, one-component water-based primer was used, Sika® HydroPrep-110, available from Sika Germany (“HP-110”). This reference primer composition is water-based and contains identical types and amounts or organosilanes as composition C1. However, Sika® HydroPrep-110 contains no organotitanates, but contains surfactants. Furthermore, it was not produced using the process according to the present invention.

### Adhesion Test Protocol 1

To test adhesion of various cured adhesives on various substrates treated with the test primer compositions, cured adhesive bonds that had been stored at room temperature (RT) under standard climatic conditions (23±2° C. and 50% rel. air humidity) were investigated regarding their adhesion properties.

The adhesives used in this test protocol were:
Sikaflex®-552 AT, a one-component, isocyanate-free elastic adhesive based on silane-functional polyurethane polymers and used as assembly adhesive in automotive manufacturing (“SF-552 AT”). It is commercially available from Sika Schweiz AG.
Sikaflex®-268, a one-component elastic polyurethane adhesive based on isocyanate-functional polymers and used as assembly adhesive and direct glazing adhesive in automotive and transportation industries (“SF-268”). It is commercially available from Sika Schweiz AG.
Sikasil® SG-500, a two-component high modulus silicone adhesive (RTV-2 silicone) used as structural glazing adhesive (“SG-500”). It is commercially available from Sika Schweiz AG.

The substrates used in this test protocol were: “Epoxy”: Grimm Epoxy Powder EP RAL 9005 deepblack, Rocholl, Germany; “Paint”: Freiotherm white laquer coated metal sheet, Rocholl, Germany; “KTL”: cathode electrocoated Kathoguard 800 Daimler Quality, Rocholl, Germany; “GFK”: Fiberglass Mitras (Polydet 1120 Gelcoat), Rocholl, Germany.

All substrate faces were cleaned immediately prior to the application of the adhesion promoter compositions by wiping-off by means of a cellulose cloth (Tela®) that had been soaked with an isopropanol/water mixture (2:1) and flashed off for at least 2 minutes prior to the application of the adhesion promoter composition.

The aqueous primer compositions were applied to the particular substrate by means of a cellulose cloth soaked therewith (Tela®, Tela-Kimberly Switzerland GmbH) and flashed off for 10 minutes (“wipe-on”). A triangular bead of the adhesive was applied by means of expression cartridge and nozzle at 23±2° C. and 50% rel. air humidity.

The cured bond with the adhesive was tested individually using different adhesive bond exposures:
After a curing time of 7 days under controlled climatic conditions (23° C., 50% rel. air humidity) (“NK”);
After 7 days immersed in water (23° C.) followed by 2 days under controlled climatic conditions (23° C., 50% rel. air humidity) (“Water 23”);
After 1 day in an oven (80° C.) (“Heat”); and/or
After 7 days immersed in water (55° C.) followed by 2 days under controlled climatic conditions (23° C., 50% rel. air humidity) (“Water 55”).

The adhesion of the adhesive was tested by means of the ‘bead adhesion test’. This involves cutting into the bead at its end just above the bond surface. The cut end of the bead is held with round-nose pliers and pulled away from the substrate. This is done by cautiously rolling up the bead onto the tip of the pliers and making a cut at right angles to the bead pulling direction down to the bare substrate. The bead pulling speed should be chosen such that a cut has to be made about every 3 seconds. The test distance must correspond to at least 8 cm. What is assessed is the adhesive remaining on the substrate after the bead has been pulled away (cohesion fracture). The adhesion properties are assessed by visual determination of the cohesive fraction of the bonding area.

The higher the proportion of cohesive fracture, the better the assessment of the adhesive bond. Test results with cohesion fractures of more than 95% are denoted in Table 2 with “1”, results with cohesion fractures of more than 75% with “2”, results with cohesion fractures of more than 25% with “3”, and results with cohesion fractures of less than 25% with “4”.

The results are summarized in Table 2.

TABLE 2
Adhesion test results of test protocol 1.

| | | | Adhesive bond exposure | | | |
|---|---|---|---|---|---|---|
| Substrate | Adhesive | Primer | NK | Water 23 | Heat | Water 55 |
| Epoxy | SF-552 AT | HP-110 | 2 | 3 | 3 | n/m |
| | | C1 | 1 | 1 | 2 | n/m |
| Paint | SF-268 | HP-110 | 2 | 2 | 2 | n/m |
| | | C1 | 1 | 1 | 1 | n/m |
| KTL | SG-500 | HP-110 | 3 | n/m | n/m | 1 |
| | | C1 | 2 | n/m | n/m | 1 |
| GFK | SG-500 | HP-110 | 1 | n/m | n/m | 4 |
| | | C1 | 1 | n/m | n/m | 1 |

Italic numbers denote adhesion properties.
“n/m” means not measured.
“HP-110” is a reference primer not according to the invention.

The results shown in Table 2 prove that the primer produced with the process according to the invention shows excellent adhesion-promoting effect on different demanding substrates and in combination with isocyanate-reactive polyurethanes as well as silicones and adhesives based on organic silane-functional polymers.

### Adhesion Test Protocol 2

This test protocol investigates the continuous adhesive properties under artificial heat ageing or accelerated weathering. For this test protocol, example primer compositions C1 and C2 according to the invention, as well as reference primer compositions C3 and HP-100 were used in comparison.

The adhesive used in test protocol 2 was a Sikaflex®-250, which is a commercially available one-component moisture-curing polyurethane adhesive which contains polyurethane prepolymers having isocyanate groups and is commercially available from Sika Schweiz AG.

The substrates used were: “Float glass (air)”: float glass in which the air side was used for adhesion testing, Rocholl, Germany, “Frit 3402”: ESG ceramic, Ferro AD 3402, Rocholl, Germany; “VSG”: VSG ceramic, Ferro 14279, Rocholl, Germany.

All substrate faces were cleaned immediately prior to the application of the adhesion promoter compositions by wiping-off by means of a cellulose cloth (Tela®) that had been soaked with an isopropanol/water mixture (2:1) and flashed off for at least 2 minutes prior to the application of the adhesion promoter composition.

The aqueous primer compositions were applied to the particular substrate by means of a cellulose cloth soaked therewith (Tela®, Tela-Kimberly Switzerland GmbH) and wiping-off 3 minutes after application with a dry cellulose cloth (Tela®, Tela-Kimberly Switzerland GmbH) (“wipe-on/off” application). A triangular bead of the adhesive was applied by means of expression cartridge and nozzle at 23±2° C. and 50% rel. air humidity. The adhesive itself was equilibrated in a closed cartridge at 60° C. for 2 h prior to application.

The cured bond with the adhesive was tested after a curing time of 10 days under controlled climatic conditions (23° C., 50% rel. air humidity) (“NK 10d”), and after subsequent heat storage (105° C.) in an oven for 3, 5, 7, and 10 days (“Heat 3d” to “Heat 10d”, respectively).

The adhesion of the adhesive was tested by means of the ‘bead adhesion test’. This involves cutting into the bead at its end just above the bond surface. The cut end of the bead is held with round-nose pliers and pulled away from the substrate. This is done by cautiously rolling up the bead onto the tip of the pliers and making a cut at right angles to the bead pulling direction down to the bare substrate. The bead pulling speed should be chosen such that a cut has to be made about every 3 seconds. The test distance must correspond to at least 8 cm. What is assessed is the adhesive remaining on the substrate after the bead has been pulled away (cohesion fracture). The adhesion properties are assessed by visual determination of the cohesive fraction of the bonding area.

In this test protocol, the amount of cohesive failure (in % based on the whole fracture pattern) was assessed and expressed in numbers (0% to 100%). The numbers were calculated as average of the individual adhesion tests on the glass and ceramic substrates specified above.

The higher the proportion of cohesive fracture, the better the assessment of the adhesive bond. Test results with cohesion fractures of less than 70% are typically considered to be inadequate. The results are summarized in Table 3.

TABLE 3
Adhesion test results of test protocol 2.
Italic numbers denote % cohesive failure.

| Adhesive | | | | |
|---|---|---|---|---|
| bond | Primer HP-110 | | | Primer C3 |
| exposure | (Ref.) | Primer C1 | Primer C2 | (Ref.) |
| NK 10 d | 99 | 100 | 100 | 100 |
| Heat 3 d | 37 | 100 | 100 | 36 |
| Heat 5 d | 19 | 100 | 93 | 15 |
| Heat 7 d | 17 | 98 | 77 | 15 |
| Heat 10 d | 15 | 78 | 52 | 11 |

It is clearly apparent from the results shown in Table 3 that the aqueous primer compositions produced by the process of the invention achieve excellent results even after prolonged heat storage, while the reference primers used as a comparison show a distinct reduction in performance in the case of prolonged heat storage.

1. A process for preparing an aqueous primer composition, comprising the steps performed in consecutive order:
a) dissolving at least one organotitanate in a concentrated acid;
b) adding water in an amount that the resulting volume ratio of (organotitanate and acid) to water is between 1:2 and 1:8 and/or the resulting pH is between 2 and 5, and waiting until a homogeneous, transparent solution is obtained;
c) adding at least one organosilane;
d) diluting the obtained mixture with additional water, until the resulting solution has a weight content of (organotitanate plus acid plus organosilane) of between 1% and 5% by weight, based on the total composition, and/or the resulting solution has a pH of between 2.5 and 4.5.

2. The process as claimed in claim 1, wherein no surfactants and no emulsifiers are added to the composition at any step.

3. The process as claimed in claim 1, wherein organosilane comprises at least one organosilane or condensate thereof that has at least one Si-bonded hydrolyzable group and has at least one primary and/or secondary amino group, and which during step c) is added after used further organosilanes having no alkaline functional groups.

4. The process as claimed in claim 1, wherein organosilane comprises organosilanes or oligomers of these organosilanes that have at least one Si-bonded hydrolyzable group and have at least one further functional group selected from alkyl groups, alkylene groups, epoxy groups, mercapto groups, hydroxyl groups and isocyanurate groups.

5. The process as claimed in claim 1, wherein step c) at least one mercaptosilane and at least one aminosilane are added.

6. The process as claimed in claim 1, wherein the concentrated acid used in step a) comprises a carboxylic acid.

7. The process as claimed in claim 1, wherein the organotitanate used in step a) comprises a tetraalkoxytitanate.

8. The process as claimed in claim 1, wherein the volume ratio of (organotitanate and acid) to water used in step b) is between 1:2 and 1:3.

9. The process as claimed in claim 1, wherein the final pH of the composition after step d) is between 3 and 4.

10. The process as claimed in claim 1, wherein the composition after step d) comprises at least 90% by weight, based on the total composition, of water, and, each based on the total weight of the aqueous composition, respectively:
0.2% to 0.6% by weight of organotitanate OT,
0.25% to 2% by weight of at least one aminosilane,
0.2% to 1% by weight of at least one mercaptosilane and/or epoxysilane, and
2% to 5% by weight of acid A.

11. The process as claimed claim 10, wherein the composition consists of the listed substances and contains as much water that all percentages add up to 100%.

12. An aqueous primer composition obtained from a process as claimed in claim 1.

13. A method comprising applying the aqueous primer composition as claimed in claim 12 to a substrate as an adhesion promoter or primer.

14. The method as claimed in claim 13, wherein the substrate is a glass or glass ceramic substrate.

15. The method as claimed in claim 13, further comprising applying a polyurethane adhesive or an adhesive based on silane-functional polymers over the aqueous primer composition.
